(19) United States
(12) Patent Application Publication
(10) Pub. No.: US 2006/0158897 A1
(43) Pub. Date: Jul. 20, 2006

(54) Receiving unit, backlight assembly and display apparatus having the same

(76) Inventors: Seong-Sik Choi, Seoul (KR); Dong-Lyoul Shin, Suwon-si (KR); Doo-Won Lee, Seoul (KR); Kui-Yong Choi, Suwon-si (KR); Jae-Hwan Chun, Suwon-si (KR); Du-Hwan Chung, Suwon-si (KR)

Correspondence Address: CANTOR COLBURN, LLP, 55 GRIFFIN ROAD SOUTH, BLOOMFIELD, CT, 06002, US

(21) Appl. No.: 11/334,146

(22) Filed: Jan. 17, 2006

(30) Foreign Application Priority Data
Jan. 18, 2005 (KR) 2005-004506

(51) Int. Cl. F21V 7/04

(52) U.S. Cl. 362/561

(57) ABSTRACT

In a backlight assembly and an LCD apparatus including a receiving unit formed by an injection molding process, a plurality of sidewalls is protruded from a bottom plate, and a receiving space is defined by the sidewalls and the bottom plate. A strength-reinforcing member is formed on a rear surface of the bottom plate to thereby reinforce a bending strength of the bottom plate. Accordingly, the receiving unit for receiving a lamp unit is formed using a material used with an injection molding process, and the strength-reinforcing member reinforces the bending strength of the bottom plate. Cost and weight of the backlight assembly and the LCD apparatus may be sufficiently reduced.

This application claims priority to Korean Patent Application No. 2005-4506 filed on Jan. 18, 2005, and all the benefits accruing therefrom under 35 U.S.C. §119, the contents of which are herein incorporated by reference in its entirety.

### BACKGROUND OF THE INVENTION

1. Field of the Invention

The present invention relates to a receiving unit, a backlight assembly, and a display apparatus having the same, and more particularly, to a receiving unit including a bottom mold in place of a metal bottom chassis, and a backlight assembly and a display apparatus using the same.

2. Description of the Related Art

A liquid crystal display (LCD) apparatus, for example, used with a television set, generally includes a backlight assembly that includes a lamp assembly and various optical sheets disposed on a bottom chassis.

However, since the bottom chassis usually comprises a metal such as galvanized iron or aluminum, elements or parts of the backlight assembly are generally engaged to the bottom chassis through a mechanical joint member such as a screw or a hook. Accordingly, there is a problem that the elements or parts of the backlight assembly cannot be formed integrally with the bottom chassis and a number of the elements or parts cannot be reduced. As a result, both manufacturing cost and manufacturing time may not be reduced since the elements and the bottom chassis are not manufactured in one united body.

### SUMMARY OF THE INVENTION

The present invention provides a receiving unit including a mold and a strength-reinforcing member. The present invention also provides a backlight assembly including the above receiving unit. The present invention further provides a display apparatus having the above backlight assembly.

In an exemplary embodiment according to the invention, a receiving unit includes a bottom plate, a plurality of sidewalls, and a strength-reinforcing member. The sidewalls protrude from the bottom plate, and a receiving space is defined by the sidewalls and the bottom plate. The strength-reinforcing member is integrally formed on a surface of the bottom plate, and reinforces a bending strength of the bottom plate.

In another exemplary embodiment according to the invention, a backlight assembly comprises an optical unit that generates a light and a receiving unit. The receiving unit includes a bottom plate, a plurality of sidewalls protruding from the bottom plate, and a strength-reinforcing member integrally formed on a rear surface of the bottom plate, wherein the strength-reinforcing member reinforces a bending strength of the bottom plate, and the optical unit is configured to be received in a receiving space defined by the sidewalls and the bottom plate.

In still another exemplary embodiment according to the invention, a display apparatus comprises an optical unit that generates a light, a display panel on which images are displayed using the light, and a first receiving unit. The first receiving unit includes a bottom plate and a plurality of sidewalls protruding from the bottom plate. The receiving unit comprises a material with which an injection molding process is used, and the optical unit and the display panel are received in a receiving space defined by the sidewalls and the bottom plate.

Accordingly, the receiving unit for receiving a lamp unit is formed using a material with which an injection molding process may be employed, and the strength-reinforcing member reinforces the bending strength of the bottom plate. Therefore, a manufacturing cost and weight of the backlight assembly and the LCD apparatus can be reduced.

### BRIEF DESCRIPTION OF THE DRAWINGS

The above and other features and advantages of the present invention will become more apparent by describing in detailed exemplary embodiments thereof with reference to the accompanying drawings, in which:

FIG. 1 is an exploded perspective view schematically showing a liquid crystal display apparatus according to an exemplary embodiment of the present invention;

FIG. 2 is an enlarged view illustrating a portion of the side mold shown in FIG. 1;

FIG. 3 is a front perspective view illustrating the bottom mold shown in FIG. 1;

FIG. 4 is a rear perspective view illustrating the bottom mold shown in FIG. 1;

FIG. 5 is a plan view illustrating the bottom mold shown in FIG. 1;

FIG. 6 is a rear view illustrating the bottom mold shown in FIG. 1;

FIG. 7 is a cross sectional perspective view taken along the line I-I′ of the bottom mold shown in FIG. 3;

FIG. 8 is a cross sectional view illustrating the rib disposed on a rear surface of the bottom plate;

FIG. 9 is a graph illustrating a deformation of the rib as a function of a width thereof when a load of 5 kgf is applied to the rear surface of the bottom plate;

FIG. 10 is a graph illustrating a deformation of the rib as a function of a protruding length thereof when a load of 5 kgf is applied to the rear surface of the bottom plate;

FIG. 11 is a graph illustrating an internal stress of the liquid crystal panel including the bottom mold and the conventional liquid crystal panel including the metal bottom chassis, respectively, as a function of a time;

FIG. 12 is a graph illustrating an internal stress of a lamp unit received in the conventional liquid crystal panel and in the liquid crystal panel of the present invention, respectively, as a function of a time;

FIG. 13 is a view illustrating a temperature distribution of a front surface of is a conventional liquid crystal display apparatus including the metal bottom chassis;

FIG. 14 is a view illustrating a temperature distribution of a rear surface of a conventional liquid crystal display apparatus including the metal bottom chassis;

FIG. 15 is a view illustrating a temperature distribution of a front surface of a liquid crystal display apparatus including the bottom mold of the present invention;

FIG. 16 is a view illustrating a temperature distribution of a rear surface of a liquid crystal display apparatus including the bottom mold of the present invention;

FIG. 17 is a graph illustrating an intensity of an electromagnetic interference (EMI) of the LCD apparatus as a function of a frequency;

FIG. 18 is a perspective view illustrating a partial portion of a bottom plate according to another embodiment of the present invention;

FIG. 19 is a perspective view illustrating a partial portion of a bottom plate according to another embodiment of the present invention; and

FIG. 20 is a perspective view illustrating a partial portion of a bottom plate according to another embodiment of the present invention.

### DESCRIPTION OF THE EMBODIMENTS

Hereinafter, the embodiments of the present invention will be described in detail with reference to the accompanied drawings.

Spatially relative terms, such as “beneath”, “below”, “lower”, “above”, “upper”, “shorter”, “lateral” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

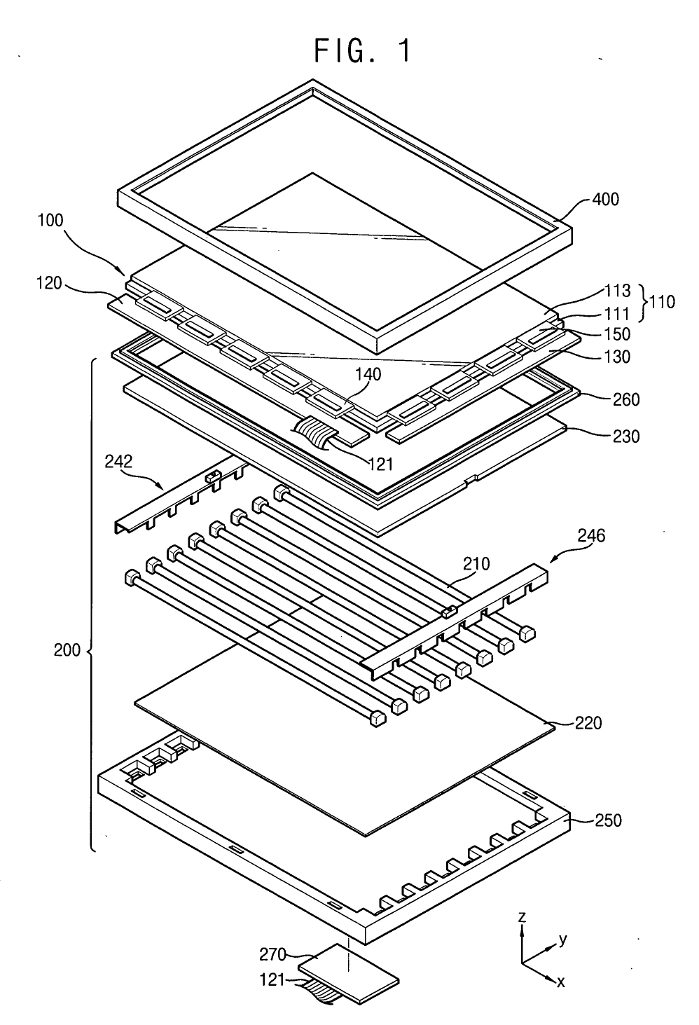

FIG. 1 is an exploded perspective view schematically showing a liquid crystal display (LCD) apparatus according to an exemplary embodiment of the present invention. In a n exemplary embodiment, a direct-illumination type lamp unit is employed with the LCD apparatus in FIG. 1.

Referring to FIG. 1, the LCD apparatus includes a display unit 100 for displaying information, and a backlight assembly 200 for providing light to the display unit 100.

The display unit 100 displays images on a panel by processing electrical image signals and controlling a light transmittance of liquid crystal disposed within the panel. In particular, the display unit 100 includes a liquid crystal panel 110 for displaying images using the liquid crystal, data and gate driving printed circuit boards (PCBs) 120 and 130 for applying a driving signal to the liquid crystal panel 110, and first and second signal transfer films 140 and 150 for electrically connecting the data and gate driving PCBs 120 and 130 and the liquid crystal panel 110. The data driving PCB 120 is attached to a data line of the liquid crystal panel 110 and the gate driving PCB 130 is attached to a gate line of the liquid crystal panel 110. In alternative embodiments, when a driving circuit that performs a function of the data driving PCB 120 and the gate driving PCB 130 is formed on the liquid crystal panel 110, the display unit 100 may not employ the data driving PCB 120 and the gate driving PCB 130.

The first signal transfer film 140 transfers signals to the data line of the liquid crystal panel 110, and the second signal transfer film 150 transfers signals to the gate line of the liquid crystal panel 110. In an exemplary embodiment, the signal transfer film includes a tape carrier package (TCP) or a chip on film (COP). When the driving circuit that performs a function of the data driving PCB 120 and the gate driving PCB 130 is formed on the liquid crystal panel 110, the display unit 100 does not employ the first signal transfer film 140 and the second signal transfer film 150. The liquid crystal panel 110, which provides a screen for the LCD apparatus, includes a thin film transistor (TFT) substrate 111, a color filter substrate 113 opposite to the TFT substrate 111, and a liquid crystal layer disposed between the TFT substrate 111 and the color filter substrate 113. The TFT substrate 111, which may be called an array substrate, is a transparent glass substrate on which a plurality of TFTs that can be switching elements are arranged in a matrix shape. A source terminal and a gate terminal of the TFT are electrically connected to the data line and the gate line, respectively, and a pixel electrode is formed at a drain terminal of the TFT. In the present embodiment, for example, the pixel electrode comprises indium tin oxide (ITO).

The color filter substrate 113 may include red, green and blue pixels (hereinafter, referred to as RGB pixels) for expressing various colors by a transmittance light passing therethrough and a black matrix layer disposed between the RGB pixels for improving a contrast of the display apparatus. A thin layer process such as a chemical vapor disposition (CVD) process may be performed for forming the RGB pixels and the black matrix on the color filter substrate 113. A common electrode may be coated on substantially a whole surface of the color filter substrate 113. In an exemplary embodiment, the common electrode also comprises the ITO.

The data line of the liquid crystal panel 110 is electrically connected to the data driving PCB 120 via the first signal transfer film 140, and the gate line of the liquid crystal panel 110 is electrically connected to the gate driving PCB 130 via the second signal transfer film 150. When an external electrical signal is applied to the data and gate driving PCBs 120 and 130, the data and gate driving PCBs 120 and 130 transfer a driving signal for driving the display unit 100 and a timing signal for controlling the driving time to the data line and the gate line of the TFT substrate 111 via the first and second signal transfer films 140 and 150, respectively.

The backlight assembly 200 includes an optical unit or lamp unit 210 for generating the light, a diffusion plate 230 disposed on the lamp unit 210 for diffusing the light and improving a luminescent uniformity of the light, and a lamp reflector 220 disposed under the lamp unit 210 for reflecting the light generated from the lamp unit 210 to the diffusion plate 230.

The lamp unit 210 includes a plurality of bar type (I-shaped) lamps arranged parallel to each other. Although the above lamp unit has been described as including the I-shaped lamp, any other lamp such as an S-shaped lamp and a U-shaped lamp could be utilized in conjunction with or in place of the I-shaped lamp. In alternative embodiments, the lamp may include a cold cathode fluorescent lamp (CCFL) in which an anode and cathode are disposed inside the lamp or an external electrode fluorescent lamp (EEFL) in which an anode and cathode are disposed outside the lamp. Although the above exemplary embodiment describes the lamp unit as a light source 210, any other optical unit or light source such as a light-emitting diode (LED) could be utilized in conjunction with or in place of the lamp unit.

The lamp unit 210, the lamp reflector 220, and the diffusion plate 230 are received in and secured to a receiving unit. Thus, the lamp unit 210, the lamp reflector 220, and the diffusion plate 230 are protected from external disturbances. In the present embodiment, the receiving unit includes first and second side molds 242 and 246 and bottom and upper molds 250 and 260, formed through an injection molding process. Accordingly, the receiving unit comprises a material appropriate to the injection molding process in conjunction with or in place of a conventional receiving unit comprised generally of metal. An example of an appropriate material is polycarbonate (PC).

The bottom mold 250 receives the lamp reflector 220, the lamp unit 210, and the first and second side molds 242 and 246. PC may be used with the injection molding process due to a superior thermal resistance and a high mechanical reliability such as shock reliability.

A control PCB 270 is disposed on a rear surface of the bottom mold 250, and is electrically connected to the data driving PCB 120 via a flexible printed circuit board (FPCB) 121. The FPCB 121 is inserted into a connector (not shown) installed to the control PCB 270, and transfers a driving signal for driving the liquid crystal panel 110 from the control PCB 270 to the data driving PCB 120.

The backlight assembly 200 further includes an inverter (not shown). The inverter provides the lamp unit 210 with electric power.

A substrate cover (not shown) may be further provided to cover the control PCB 270 and installed to the bottom mold 250 for reducing or effectively eliminating undesirable influences on the control PCB 270.

The upper mold 260 is disposed on the diffusion plate 230, and makes contact with the diffusion plate 230 to thereby press the diffusion plate 230 to the first and second side molds 242 and 246. Accordingly, the diffusion plate 230 is secured to the first and second side molds 242 and 246. The liquid crystal panel 110 is disposed on the upper mold 260. Here, the data driving PCB 120 connected to the liquid crystal panel 110 may be arranged to a sidewall or to a rear surface of the bottom mold 250.

A plurality of optical sheets (not shown) may be further disposed on the diffusion plate 230. The optical sheets include a diffusion sheet, first and second prism sheets, and first prisms on the first prism sheets substantially perpendicular to second prisms on the second prism sheets. Here, the gate driving PCB 130 connected to the liquid crystal panel 110 may be arranged to a sidewall or to a rear surface of the bottom mold 250.

A top chassis 400 is disposed on the liquid crystal panel 110 for preventing the display unit 100 from drifting substantially from the diffusion plate 230. The top chassis 400 is generally frame shaped including an edge portion configured to be substantially a long a peripheral portion of the diffusion plate 230, and having a substantially open portion defined by the edge portion. Here, the edge portion of the top chassis 400 includes corner portions formed substantially at right angles, so that the top chassis 400 presses against a portion of a peripheral portion of the liquid crystal panel 110 and also presses against a sidewall of the bottom mold 250. Accordingly, the liquid crystal panel 110 is secured to the bottom mold 250 by the top chassis 400. In an exemplary embodiment, at least one protruding portion is formed on an inner sidewall of the top chassis 400, and at least one opening is formed on a sidewall of the bottom mold 250 such that the opening is combined to the protruding portion of the top chassis 400. In alternative embodiments, at least one opening is formed on a sidewall of the top chassis 400, and at least one protruding portion is formed on a sidewall of the bottom mold 250 such that the protruding portion engages the opening of the top chassis 400. The top chassis 400 may be formed through an injection molding process.

In another exemplary embodiment, a metal bottom chassis may be employed with the bottom mold 250 formed by an injection-molding process, so that a weight of the backlight assembly 200 and the LCD apparatus may be reduced in addition to the manufacturing cost.

Hereinafter, a Cartesian coordinate system is provided for convenience such that a z-axis penetrates through the LCD apparatus, a y-axis substantially perpendicular to the z-axis is substantially parallel with the sidewall of the bottom mold 250, and an x-axis is substantially perpendicular to the z-axis and the y-axis. A +z direction advances toward the top chassis 400 from the bottom mold 250, and a +y direction advances from a lateral side of the liquid crystal panel 110 corresponding to the data driving PCB 120 in FIG. 1. A +x direction advances toward a lateral side of the liquid crystal panel 110 corresponding to the gate driving PCB 130. A −z direction, a −y direction and a −x direction are reverse to the +z, +y and +x directions, respectively.

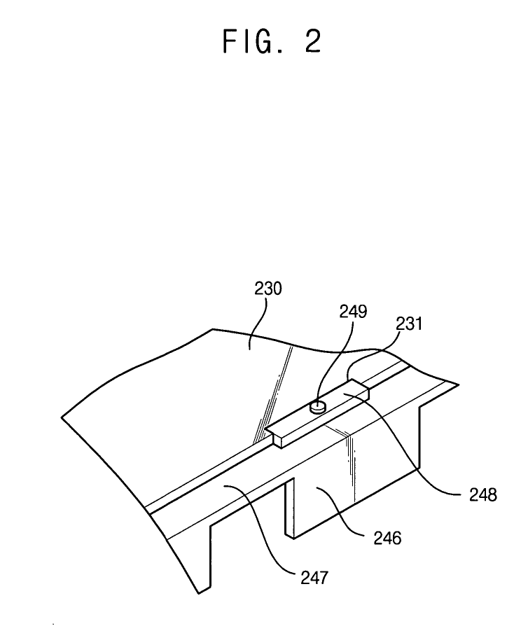

FIG. 2 is an enlarged view illustrating a portion of the side molds 242 and 246 shown in FIG. 1. In the exemplary embodiment illustrated, the diffusion plate 230 and the optical sheets are disposed on a top surface 247 of the second side mold 246. However, the diffusion plate 230 is only shown in FIG. 2 as an example of a type of optical sheet and is not intended to be limited to that type of optical sheet disposed on the second side mold 246.

Referring to FIG. 2, a second plate-securing member 248 for securing the diffusion plate 230 and a second sheet-securing member 249 for securing the optical sheets are formed on the top surface 247 of the second side mold 246. The second plate-securing member 248 protrudes from the top surface 247 of the second side mold 246 and is inserted into a recessed portion 231 of the diffusion plate 230, so that the diffusion plate 230 is guided toward and secured to the second side mold 246. Accordingly, the diffusion plate 230 is prevented from substantially moving relative to the second side mold 246. The second sheet-securing member 249 protrudes from the second plate-securing member 248, and is inserted into an opening of the optical sheets. Accordingly, the optical sheets are prevented from substantially moving relative to the second side mold 246. The second sheet-securing member 249 may be formed on the top surface 247 of the second side mold 246 as well as on the second plate-securing member 248. Although not shown in FIG. 2, the first side mold 242 also includes a first plate-securing member corresponding to the second plate-securing member 248, a first sheet-securing member corresponding to the second sheet-securing member 249, whereby the diffusion plate 230 and the optical sheets are secured to the first side mold 242 by the first plate-securing member and the first sheet-securing member, thereby preventing the diffusion plate 230 and the optical sheets from substantially moving relative to the first side mold 242. The first and second plate-securing members may be arranged to face each other or to alternate with each other.

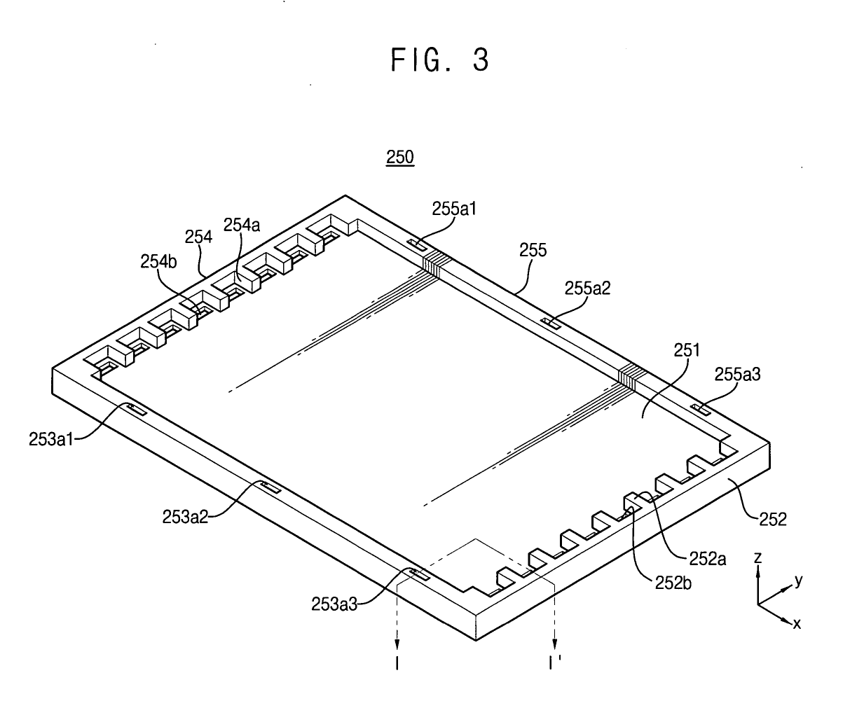

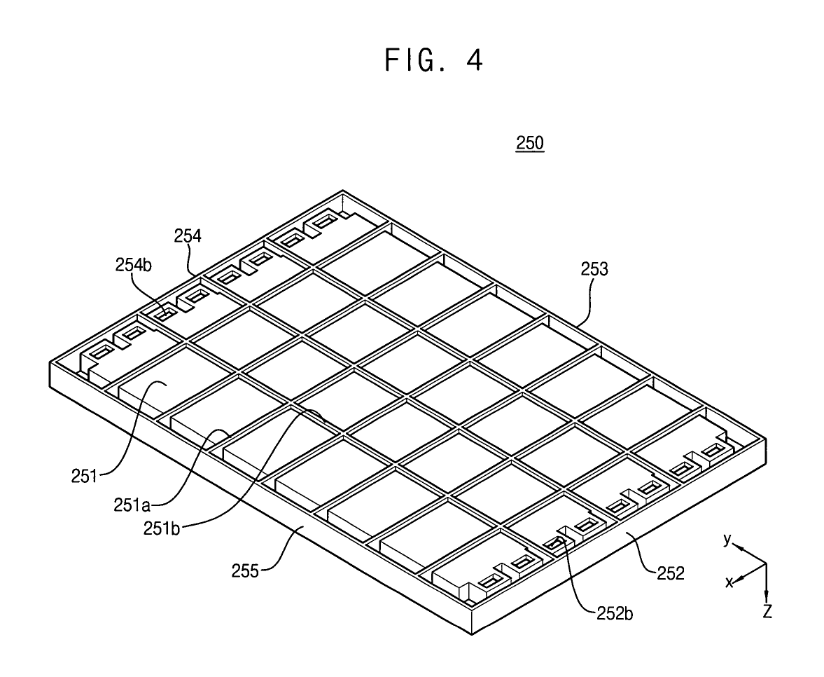

FIG. 3 is a front perspective view illustrating the bottom mold shown in FIG. 1, and FIG. 4 is a rear perspective view illustrating the bottom mold shown in FIG. 1.

Referring to FIGS. 1 to 4, the bottom mold 250, according to an exemplary embodiment of the present invention, includes a bottom plate 251, first, second, third, and fourth sidewalls 252, 253, 254, and 255 that protrude from a bottom surface of the bottom plate 251 toward the +z direction, and first and second ribs 251a and 251b that protrude from a rear surface of the bottom plate 251 toward the −z direction. The first, second, third, and fourth sidewalls 252, 253, 254, and 255 and the bottom surface of bottom plate 251 define a receiving space of a predetermined size. The first and second ribs 251a and 251b or strength-reinforcing members reinforce a bending strength of the bottom plate 251.

The first sidewall 252 protrudes from a first edge of the bottom plate 251 toward the +z direction, and a plurality of protruding portions 252a is formed on an inner surface of the first sidewall 252 extending toward the −x direction. A plurality of holes 252b extending through the bottom plate 251 is formed between the protruding portions 252a exposing the first edge of the bottom plate 251. A lamp holder for covering an end portion of the lamp may be received in the holes 252b. Of course, alternative embodiments include configurations where some or all of the holes 252b may not completely protrude through bottom plate 251.

The second sidewall 253 protrudes from a second edge of the bottom plate 251 toward the +z direction, and a first end portion thereof is connected to a second end portion of the first sidewall 252. First, second, and third bottom securing holes 253a1, 253a2, and 253a3 are formed on a top surface of the second sidewall 253, and the upper mold 260 is secured to the bottom mold 250 by the bottom securing holes 253a1, 253a2, and 253a3.

The third sidewall 254 protrudes from a third edge of the bottom plate 251 toward the +z direction, and a first end portion thereof is connected to a second end portion opposite to the first end portion of the second sidewall 253. A plurality of protruding portions 254a is formed on an inner surface of the third sidewall 254 extending toward the +x direction. A plurality of holes 254b extending through the bottom plate 251 is formed between the protruding portions 254a. A lamp holder for covering an end portion of the lamp may be received in the holes 254b. Of course, alternative embodiments include configurations where some or all holes 254b may not completely protrude through bottom plate 251.

The fourth sidewall 255 protrudes from a fourth edge of the bottom plate 251 toward the +z direction, and a first end portion thereof is connected to a second end portion opposite to the first end portion of the third sidewall 253, and a second end portion thereof is connected to a first end portion opposite to the second end portion of the first sidewall 252. Fourth, fifth, and sixth bottom securing holes 255a1, 255a2, and 255a3 are formed on a top surface of the fourth sidewall 255, and the upper mold 260 is secured to the bottom mold 250 by the bottom securing holes 255a1, 255a2, and 255a3.

A plurality of the first ribs 251a is disposed on the rear surface of the bottom plate 251 substantially parallel with the first and third sidewalls 252 and 254, or perpendicular to the longitudinal sidewalls 253 and 255, to thereby reinforce the bending strength of the bottom plate against a bending moment with respect to the z-axis. A plurality of the second ribs 251b is disposed on the rear surface of the bottom plate 251 substantially parallel with the second and fourth sidewalls 253 and 255, or the longitudinal sidewalls, to thereby reinforce the bending strength of the bottom plate against the bending moment with respect to the z-axis.

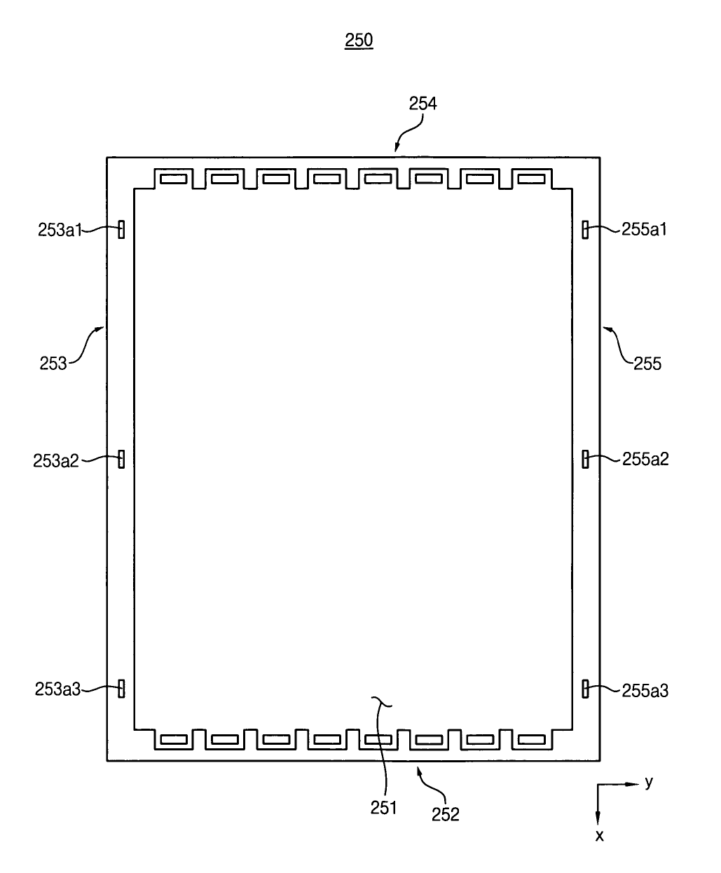

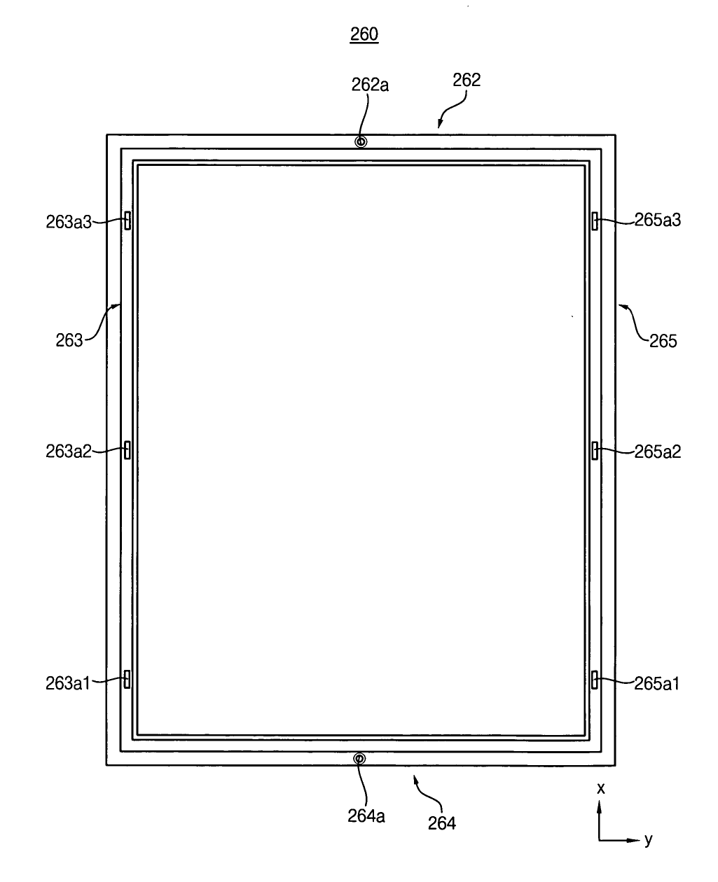

FIG. 5 is a plan view illustrating the bottom mold shown in FIG. 1, and FIG. 6 is a rear view illustrating the upper mold shown in FIG. 1.

Referring to FIGS. 1 to 6, the upper mold 260 is also formed into a frame including first, second, third, and fourth sidewalls 262, 263, 264, and 265, respectively, corresponding to the first, second, third, and fourth sidewalls 252, 253, 254, and 255 of the bottom mold 250. A first upper securing hole 262a for securing the upper mold 260 to the first side mold 242 is formed on a rear surface of the first sidewall 262 of the upper mold 260, and a second upper securing hole 264a for securing the upper mold 260 to the second side mold 246 is formed on a rear surface of the third sidewall 264 of the upper mold 260. The second sheet-securing member 249 on the second side mold 246 and the first sheet-securing member on the first side mold 242 are inserted into the first and second upper securing holes 264a and 262a, respectively.

First, second, third, and fourth stepped portions protrude from an inner surface of the first, second, third, and fourth sidewalls 262, 263, 264, and 265 of the upper mold 260 toward the receiving space. First, second, and third hook securing members 263a1, 263a2, and 263a3 protrude from the second stepped portion along the −z direction, and fourth, fifth, and sixth hook securing members 265a1, 265a2, and 265a3 protrude from the fourth stepped portion along the −z direction. The first, second, third, fourth, fifth, and sixth hook securing members 263a1, 263a2, 263a3, 265a1, 265a2, and 265a3 are inserted into the first, second, third, fourth, fifth, and sixth bottom securing holes 253a1, 253a2, 253a3, 255a1, 255a2, and 255a3, respectively, so that the upper mold 260 is secured to the bottom mold 250. A plurality of the optical sheets may be sequentially stacked on the stepped portions along the z-axis. In exemplary embodiments, the optical sheets may include a diffusion sheet, a condensing sheet, and a protection sheet.

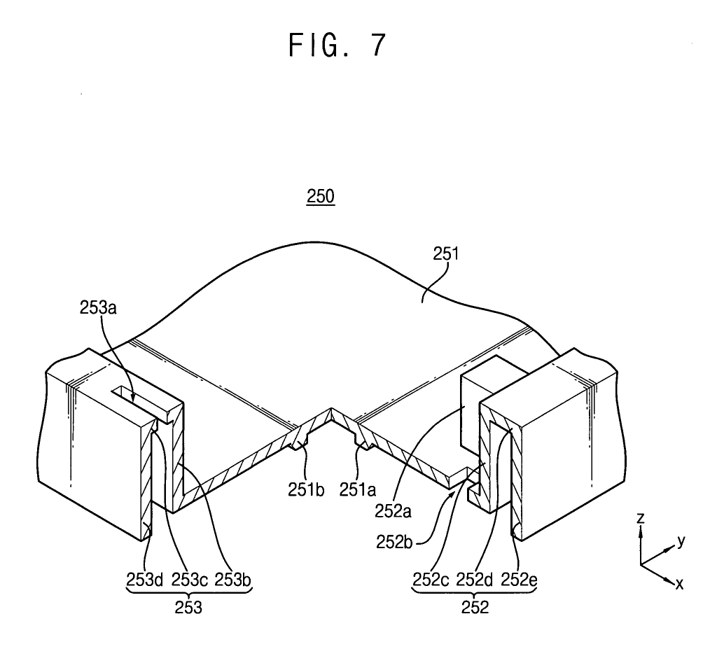

FIG. 7 is a cross sectional perspective view taken along line I-I′ of the bottom mold shown in FIG. 3.

Referring to FIG. 7, the first sidewall 252 of the bottom mold 250 includes a first member 252c protruded from the first edge portion of the bottom plate 251 along the +z direction, a second member 252d protruded from an end portion of the first member 252c along the +x direction, and a third member 252e protruded from an end portion of the second member 252d along the −z direction. Although the present embodiment describes the first member 252c protruding from the bottom plate 251 at a right angle, the first member 252c may protrude from the bottom plate 251 at an acute angle less than about 90°.

The second sidewall 253 of the bottom mold 250 includes a fourth member 253b protruded from the second edge portion of the bottom plate 251 along the +z direction, a fifth member 253c protruded from an end portion of the fourth member 253b along the −y direction, and a sixth member 253d protruded from an end portion of the fifth member 253c along the −z direction. The bottom securing holes 253a1, 253a2, 253a3 are formed on the fifth member 253c for securing with the upper mold 260. Although the present embodiment describes the fourth member 253b protruding from the bottom plate 251 at a right angle, the fourth member 253b may protrude from the bottom plate 251 at an acute angle less than about 90°.

The first rib 251a is disposed on a rear surface of the bottom plate 251 substantially parallel with the first sidewall 252, and the second rib 251b is disposed on a rear surface of the bottom plate 251 substantially parallel with the second sidewall 253. Hereinafter, the first and second ribs 251a and 251b are described in more detail.

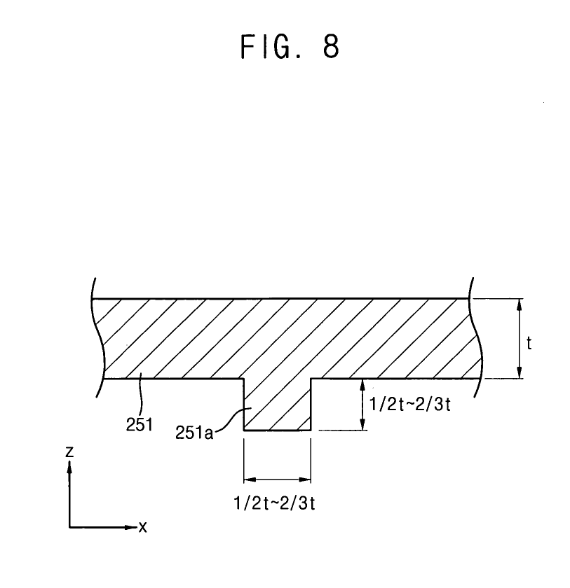

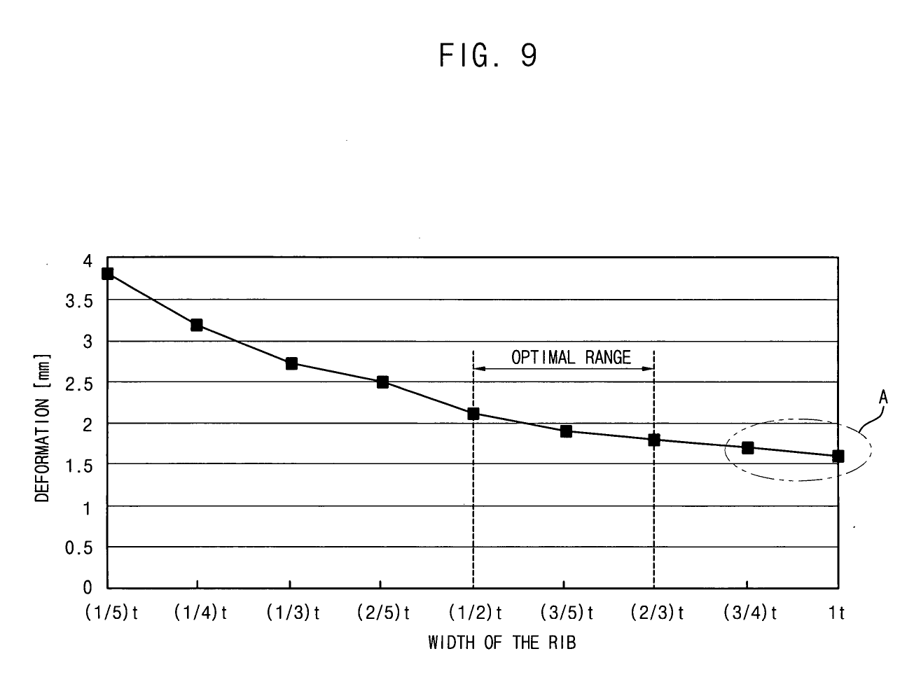

FIG. 8 is a cross sectional view illustrating the rib disposed on the rear surface of the bottom plate 251. FIG. 9 is a graph illustrating a deformation of the rib as a function of a width thereof when a load of 5 kgf is applied to the rear surface of the bottom plate 251, and FIG. 10 is a graph illustrating a deformation of the rib as a function of a protruding length thereof when a load of 5 kgf is applied to the rear surface of the bottom plate 251. In the present embodiment, each of the ribs has a width in a range of about (½)t to about (⅔)t and a protruding length in a range of about (½)t to about (⅔)t. A thickness of the bottom plate 251 defines t in a z-axis direction.

Referring to FIG. 9, the deformation of the rib is decreased as the width of the rib is increased when the load of 5 kgf is applied to the bottom plate 251 along the z-axis direction. When the width of the rib is about (⅕)t, the deformation of the rib is measured to be about 3.8 mm, and when the width of the rib is about (¼)t, the deformation of the rib is measured to be about 3.3 mm. In addition, when the width of the rib is about (⅓)t, the deformation of the rib is measured to be about 2.8 mm, and when the width of the rib is about (⅖)t, the deformation of the rib is measured to be about 2.5 mm. When the width of the rib is about (½)t, the deformation of the rib is measured to be about 2.1 mm, and when the width of the rib is about (⅗)t, the deformation of the rib is measured to be about 1.9 mm. When the width of the rib is about (⅔)t, the deformation of the rib is measured to be about 1.8 mm. Furthermore, when the width of the rib is about (¾)t, the deformation of the rib is measured to be about 1.7 mm, and when the width of the rib is the same as the thickness t of the bottom plate 251, the deformation of the rib is measured to be about 1.6 mm. However, when the width of the rib is greater than about (⅔)t as indicated as a capital letter A in FIG. 9, the rib may be deflected during the injection molding process even though the bending strength of the bottom plate is improved.

In FIG. 10, the deformation of the rib is decreased as the protruding length of the rib is increased when the load of 5 kgf is applied to the bottom plate 251 along the z-axis direction. When the protruding length of the rib is about (⅕)t, the deformation of the rib is measured to be about 4.3 mm, and when the protruding length of the rib is about (¼)t, the deformation of the rib is measured to be about 3.9 mm. In addition, when the protruding length of the rib is about (⅓)t, the deformation of the rib is measured to be about 3.2 mm, and when the protruding length of the rib is about (⅖)t, the deformation of the rib is measured to be about 2.8 mm. When the protruding length of the rib is about (½)t, the deformation of the rib is measured to be about 2.3 mm, and when the protruding length of the rib is about (⅗)t, the deformation of the rib is measured to be about 2.2 mm.

When the protruding length of the rib is about (⅔)t, the deformation of the rib is measured to be about 2.0 mm. Furthermore, when the protruding length of the rib is about (¾)t, the deformation of the rib is measured to be about 1.9 mm, and when the protruding length of the rib is the same as the thickness t of the bottom plate 251, the deformation of the rib is measured to be about 1.8 mm. However, when the protruding length of the rib is greater than about (⅔)t as indicated as a capital letter B in FIG. 10, the rib may be deflected during the injection molding process even though the bending strength of the bottom plate is improved.

Although the first and second ribs 251a and 251b illustrated in FIGS. 7 and 8 are substantially trapezoidal, rectangular, or square shaped, it is intended that the first and second ribs 251a and 251b or the strength-reinforcing members can be formed as other geometric shapes including those having curved or hollow portions.

An impact reliability test was carried out for the liquid crystal panel including the bottom mold of the present invention as compared with the conventional liquid crystal panel including a metal bottom chassis.

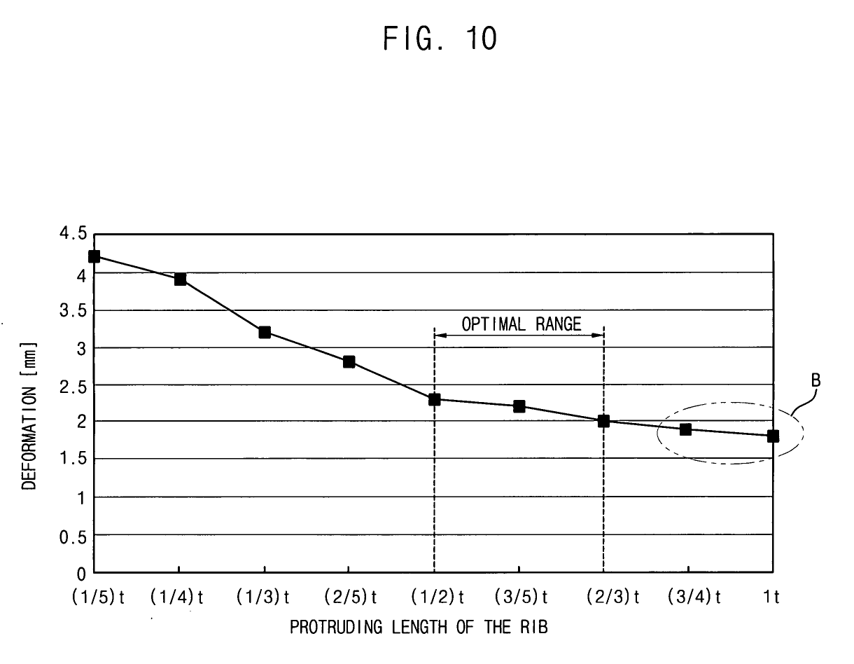

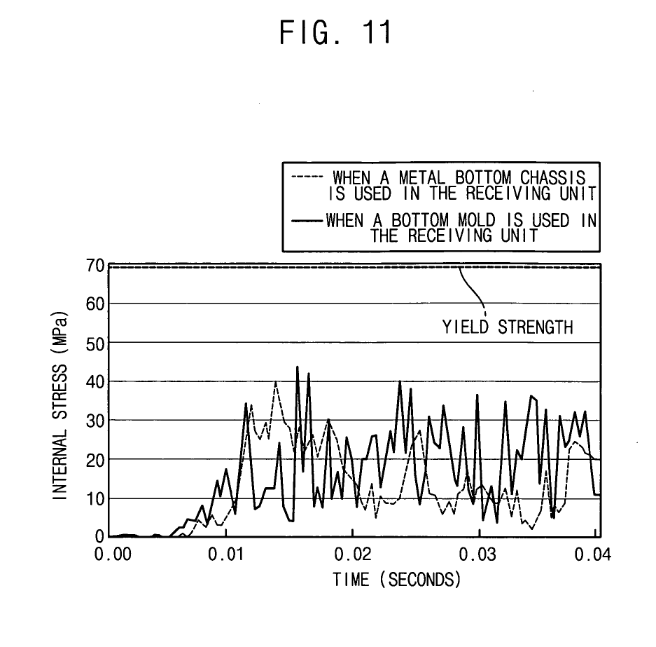

FIG. 11 is a graph illustrating an internal stress of the liquid crystal panel including the bottom mold and the conventional liquid crystal panel including the metal bottom chassis, respectively, as a function of a time.

Referring to FIG. 11, when an external impact was applied to the conventional liquid crystal panel including the metal bottom chassis, the internal stress of the liquid crystal panel was measured to be about 10 Mpa (or 1×10⁸ dyne/cm²) at a time of 0.01 second, about 40 Mpa at a time of 0.015 second, about 28 Mpa at a time of 0.025 second, and about 28 Mpa at a time of 0.038 second.

In contrast, when the external impact was applied to the liquid crystal panel including the bottom mold according to the present invention, an internal stress of the liquid crystal panel was measured to be about 18 Mpa at a time of 0.01 second, about 45 Mpa at a time of 0.015 second, about 40 Mpa at a time of 0.025 second, and about 32 Mpa at a time of 0.038 second.

Although the internal stress of the liquid crystal panel according to the present invention is higher than that of the conventional liquid crystal panel, the internal stress of the liquid crystal panel is much lower than an allowable yield strength of the liquid crystal panel, which is about 70 Mpa. As a result, the impact reliability test on the liquid crystal panel shows that the liquid crystal panel has sufficient impact reliability even though the metal bottom chassis is employed with the bottom mold.

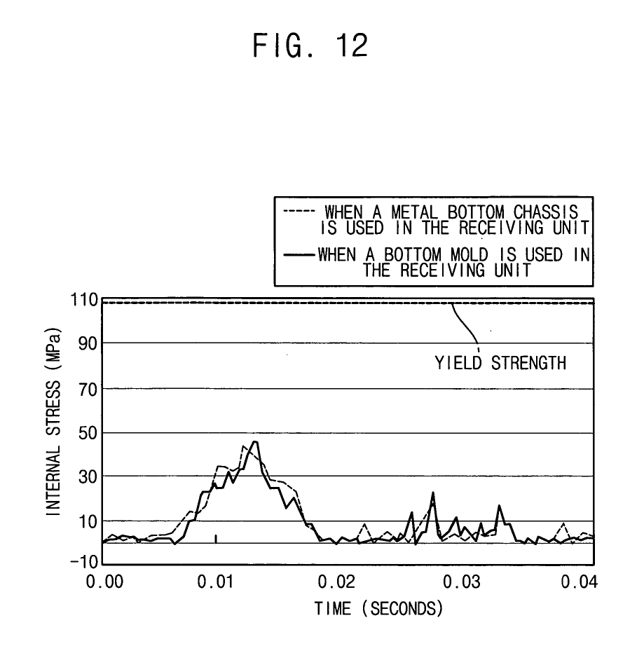

FIG. 12 is a graph illustrating an internal stress of a lamp unit received in the conventional liquid crystal panel and in the liquid crystal panel of the present invention, respectively, as a function of a time.

Referring to FIG. 12, when an external impact was applied to the lamp unit in the conventional liquid crystal panel including the bottom chassis, an internal stress of the lamp unit was about 45 Mpa at a time of 0.014 second as a maximum stress, and then gradually reduced to be about 0 Mpa. Thereafter, the internal stress was measured to about 20 Mpa at a time of 0.028 second, and then gradually reduced to be about 0 Mpa.

In contrast, when the external impact was applied to the lamp unit in the liquid crystal panel including the bottom mold according to the present invention, an internal stress of the lamp unit was about 45 Mpa at a time of 0.014 second as a maximum stress, and then gradually reduced to be about 0 Mpa. Thereafter, the internal stress was measured to about 20 Mpa at a time of 0.028 second, and then gradually reduced to be about 0 Mpa.

FIG. 12 shows that an average internal stress of the lamp unit in the liquid crystal panel of the present invention was higher than that of the lamp unit in the conventional liquid crystal panel, as much as a bout 9% of the average internal stress of the lamp unit in the conventional liquid crystal panel. However, FIG. 12 also indicates that the average internal stress of the lamp unit in the liquid crystal panel of the present invention is much lower than an allowable yield strength of the lamp unit, which is about 110 Mpa. As a result, the impact reliability test on the lamp unit shows that the substitution of the bottom mold for the metal bottom chassis has a minimal effect on the impact reliability of the lamp unit.

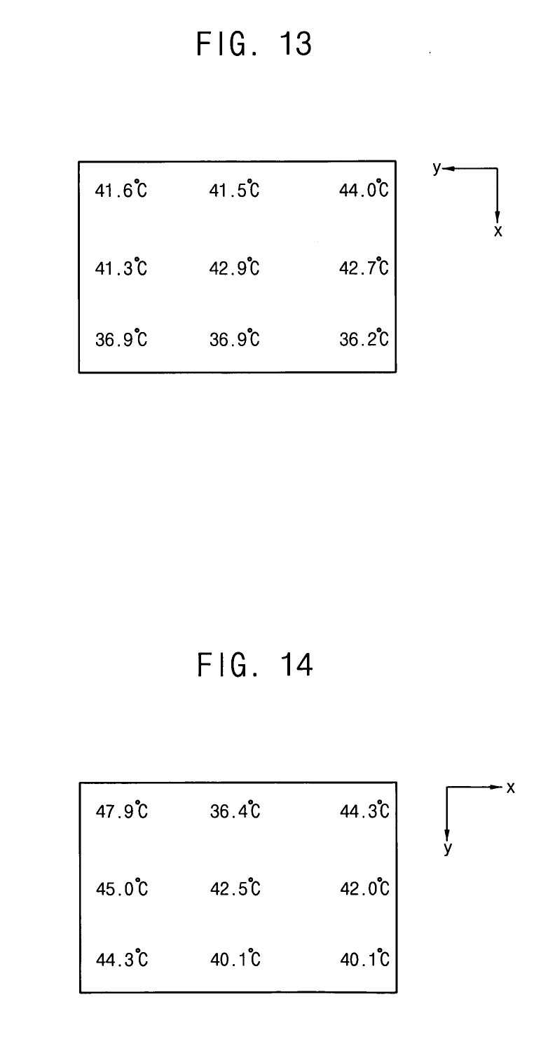

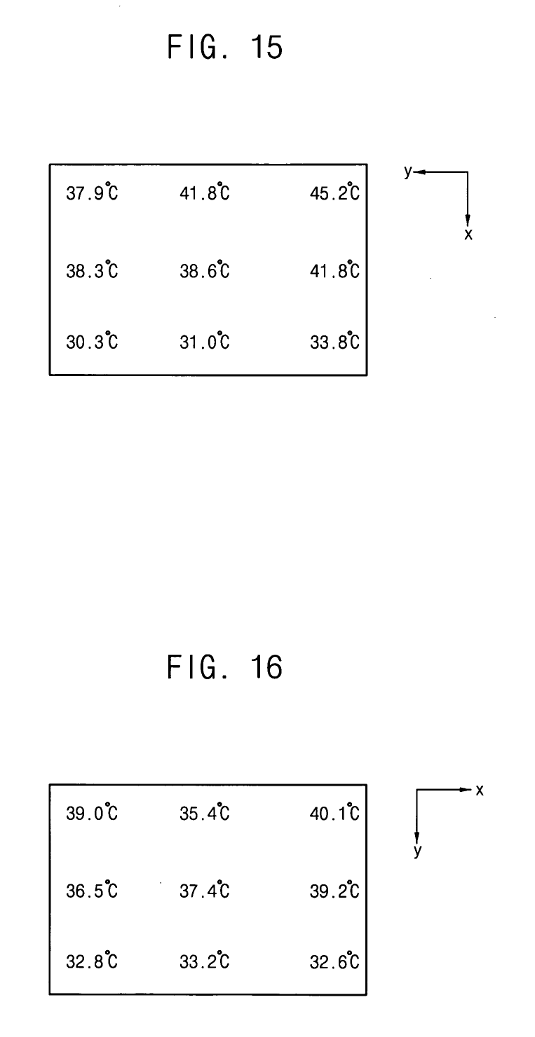

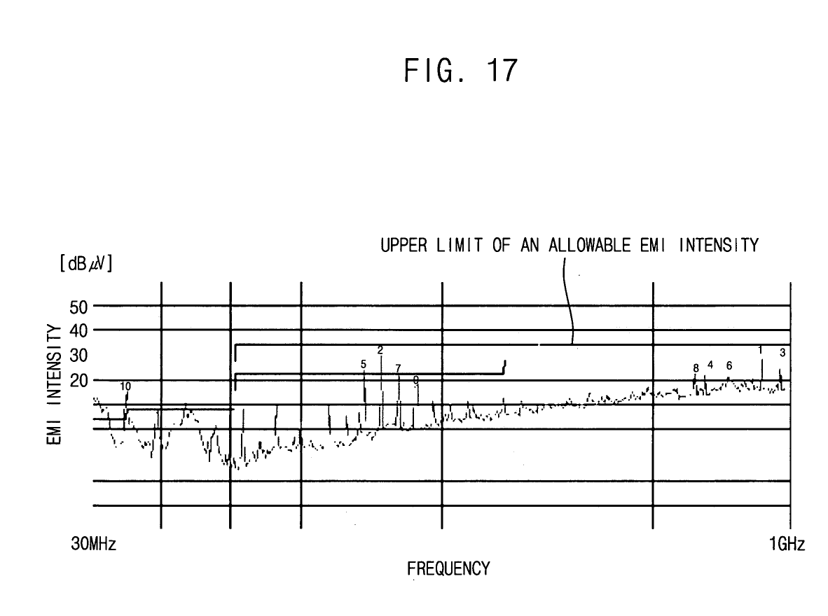

FIG. 13 is a view illustrating a temperature distribution of a front surface of a conventional liquid crystal display apparatus including the metal bottom chassis, and FIG. 14 is a view illustrating a temperature distribution of a rear surface of a conventional liquid crystal display apparatus including the metal bottom chassis. FIG. 15 is a view illustrating a temperature distribution of a front surface of a liquid crystal display apparatus including the bottom mold according to the present invention, and FIG. 16 is a view illustrating a temperature distribution of a rear surface of a liquid crystal display apparatus including the bottom mold according to the present invention.

Referring to FIG. 13, on the front surface of the liquid crystal display apparatus including the metal bottom chassis, temperatures along an upper row line are about 41.6° C., 41.5° C., and 44.0° C., and temperatures along a middle row line are about 41.3° C., 42.9° C., and 42.7° C. In addition, temperatures along a lower row line are about 36.9° C., 36.9° C., and 36.2° C.

In contrast, as shown in FIG. 15, on the front surface of the liquid crystal display apparatus including the bottom mold according to the present invention, temperatures along an upper row line are about 37.9° C., 41.8° C., and 45.2° C., and temperatures along a middle row line are about 38.3° C., 38.6° C., and 41.8° C. In addition, temperatures along a lower row line are measured to be about 30.3° C., 31.0° C., and 33.8° C.

The comparison of FIG. 13 and FIG. 15 indicates that an average temperature of the front surface is lower on the LCD apparatus including the bottom mold than on the LCD apparatus including the metal bottom chassis.

Referring to FIG. 14, on the rear surface of the liquid crystal display apparatus including the metal bottom chassis, temperatures along an upper row line are about 47.9° C., 36.4° C., and 44.3° C., and temperatures along a middle row line are about 45.0° C., 42.5° C., and 42.0° C. In addition, temperatures along a lower row line are measured to be about 44.3° C., 40.1° C., and 40.1° C.

In contrast, as shown in FIG. 16, on the rear surface of the liquid crystal display apparatus including the bottom mold according to the present invention, temperatures along an upper row line are be about 39.0° C., 35.4° C., and 40.1° C., and temperatures along a middle row line are about 36.5° C., 37.4° C., and 39.2° C. In addition, temperatures along a lower row line are about 32.8° C., 33.2° C., and 32.6° C.

The comparison of FIG. 14 and FIG. 16 indicates that an average temperature of the rear surface is also lower on the LCD apparatus including the bottom mold than on the LCD apparatus including the metal bottom chassis.

FIGS. 13 to 16 show that the substitution of the metal bottom chassis with the bottom mold reduces the temperature of the liquid crystal panel as much as about 3° C., so that employing the metal bottom chassis with the bottom mold has a minimal thermal effect on the liquid crystal panel.

FIG. 17 is a graph illustrating an intensity of an electromagnetic interference (EMI) of the LCD apparatus as a function of a frequency.

Referring to FIG. 17, the EMI intensity of the LCD apparatus is lower than about 40 dBμV at a frequency range between about 30 MHz and about 1 GHz. The EMI intensity of the LCD apparatus is about 27.66 dBμV at a frequency of about 81 MHz, about 31.82 dBμV at a frequency of about 408 MHz, about 34.6 dBμV at a frequency of about 433 MHz, and about 31.28 dBμV at a frequency of about 457 MHz.

In addition, the EMI intensity of the LCD apparatus is about 29.14 dBμV at a frequency of about 481 MHz, about 31.23 dBμV at a frequency of about 864 MHz, about 32.28 dBμV at a frequency of about 879 MHz, and about 31.68 dBμV at a frequency of about 910 MHz. Furthermore, the EMI intensity of the LCD apparatus is about 36.44 dBμV at a frequency of about 959 MHz and about 34.06 dBμV at a frequency of about 983 MHz.

The above measured EMI intensities with respect to a corresponding frequency are shown at Table 1.

TABLE 1

| | | | | | EMI |
|---|---|---|---|---|---|
| Peak | Frequency | EMI intensity | Peak | Frequency | intensity |
| number | (MHz) | (dBμV) | number | (MHz) | (dBμV) |
| 1 | 959 | 36.44 | 6 | 910 | 31.66 |
| 2 | 433 | 34.60 | 7 | 457 | 31.28 |
| 3 | 983 | 34.06 | 8 | 864 | 31.23 |
| 4 | 897 | 32.28 | 9 | 481 | 29.14 |
| 5 | 408 | 31.82 | 10 | 81 | 27.66 |

Table 1 shows that the EMI intensity of the LCD apparatus of the present invention is below the upper limit of an allowable EMI intensity, so that the substitution of the bottom mold for the metal bottom chassis has a minimal effect on the EMI characteristic of the LCD apparatus.

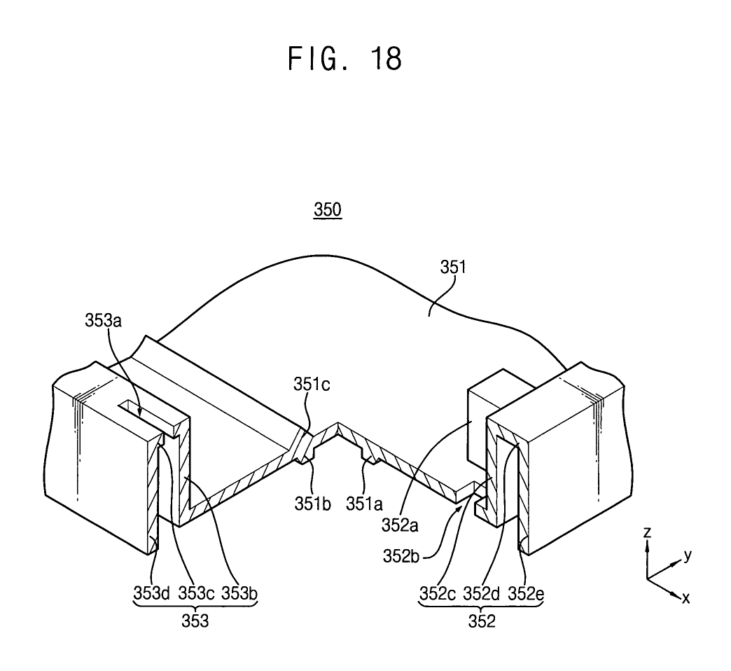

FIG. 18 is a perspective view illustrating a partial portion of a bottom plate according to an alternative embodiment of the present invention.

Referring to FIG. 18, a bottom mold 350 includes a bottom plate 351 having a triangular shaped protruding portion formed on a bottom surface thereof substantially parallel with the lamps and a lattice type rib formed on a rear surface thereof.

The first sidewall 352 of the bottom mold 350 includes a first member 352c protruded from the first edge portion of the bottom plate 351 substantially along the +z direction, a second member 352d protruded from an end portion of the first member 352c substantially along the +x direction, and a third member 352e protruded from an end portion of the second member 352d substantially along the −z direction. Although the present embodiment describes the first member 352c as protruding from the bottom plate 351 at a right angle, the first member 352c can protrude from the bottom plate 351 at an acute angle less than about 90°.

The second sidewall 353 of the bottom mold 350 includes a fourth member 353b protruded from the second edge portion of the bottom plate 351 substantially along the +z direction, a fifth member 353c protruded from an end portion of the fourth member 353b substantially along the −y direction, and a sixth member 353d protruded from an end portion of the fifth member 353c along the −z direction. The bottom securing holes are formed on the fifth member 353c for securing the bottom mold 350 to the upper mold 260. Although the present embodiment describes the fourth member 353b as protruding from the bottom plate 351 at a right angle, the fourth member 353b can protrude from the bottom plate 351 at an acute angle less than about 90°.

Similar to bottom mold 250 illustrated in FIG. 7, bottom mold 350 includes a plurality of protruding portions 352a formed on an inner surface of the first sidewall 352 extending toward the −x direction, and plurality of holes 352b extending through the bottom plate 351 formed between the protruding portions 352a.

A first rib 351a is disposed on the rear surface of the bottom plate 351 substantially parallel with the first sidewall 352, and the second rib 351b is disposed on the rear surface of the bottom plate 351 substantially parallel with the second sidewall 353. The triangular shaped protruding portion 351c is formed on the bottom surface corresponding to, or in other words, opposite the rear surface of the bottom plate 351 extending substantially in the +x direction, and reinforces strength of the bottom plate 351. A reflecting plate such as a reflection sheet may be disposed on the triangular shaped protruding portion 351c, so that a dark region due to two lamps adjacent to each other is minimized.

Although the first and second ribs 351a and 351b illustrated in FIG. 18 are substantially trapezoid shaped, it is intended that the first and second ribs 351a and 351b or strength-reinforcing members can be formed as other geometric shapes including those having curved or hollow portions. Additionally, it is intended that protruding portion 351c can be formed as geometric shapes other than the triangular shape illustrated in FIG. 18.

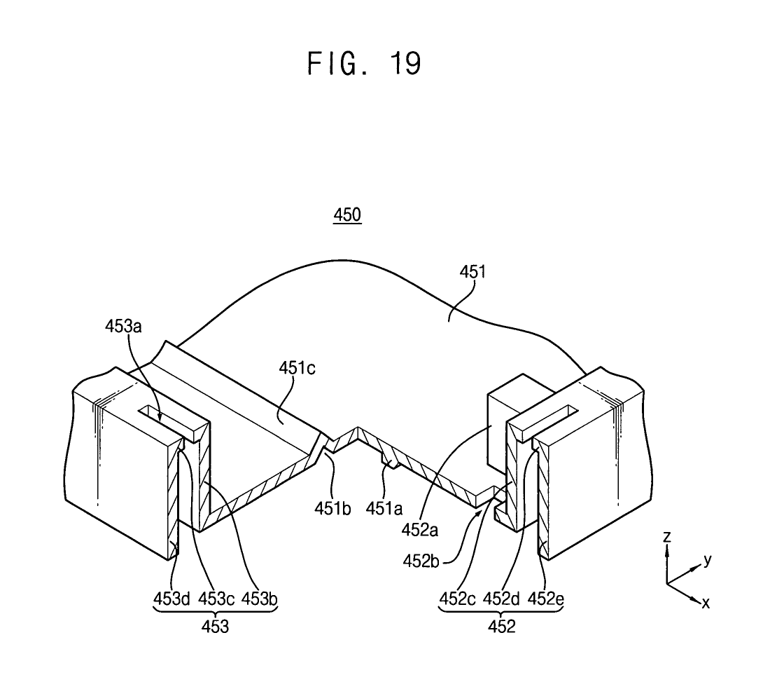

FIG. 19 is a perspective view illustrating a partial portion of a bottom plate according to another embodiment of the present invention.

Referring to FIG. 19, a bottom mold 450 includes a bottom plate 451 having a triangular shaped protruding portion formed on a bottom surface thereof substantially parallel with the lamps, a groove formed on a rear surface thereof corresponding to the triangular shaped protruding portion, and a rib substantially perpendicular to the lamps formed on a rear surface thereof.

The first sidewall 452 of the bottom mold 450 includes a first member 452c protruded from the first edge portion of the bottom plate 451 substantially along the +z direction, a second member 452d protruded from an end portion of the first member 452c substantially along the +x direction, and a third member 452e protruded from an end portion of the second member 452d substantially along the −z direction. Although the present embodiment describes the first member 452c as protruding from the bottom plate 451 at a right angle, the first member 452c can protrude from the bottom plate 451 at an acute angle less than about 90°.

The second sidewall 453 of the bottom mold 450 includes a fourth member 453b protruded from the second edge portion of the bottom plate 451 substantially along the +z direction, a fifth member 453c protruded from an end portion of the fourth member 453b substantially along the −y direction, and a sixth member 453d protruded from an end portion of the fifth member 453c along the −z direction. The bottom securing holes are formed on the fifth member 453c for securing to the upper mold 260. Although the present embodiment describes the fourth member 453b as protruding from the bottom plate 451 at a right angle, the fourth member 453b can protrude from the bottom plate 451 at an acute angle less than about 90°.

Similar to bottom mold 250 illustrated in FIG. 7, bottom mold 450 includes a plurality of protruding portions 452a formed on an inner surface of the first sidewall 452 extending toward the −x direction, and plurality of holes 452b extending through the bottom plate 451 formed between the protruding portions 452a.

The rib 451a is disposed on the rear surface of the bottom plate 451 substantially in the y-axis direction, and the groove 451b is disposed on the rear surface of the bottom plate 451 substantially in the x-axis direction. The groove 451b may be formed a predetermined depth as measured from the rear surface of the bottom plate. The triangular shaped protruding portion 451c is formed on the bottom surface opposite the rear surface of the bottom plate 451 corresponding to the groove 451b in the x-axis direction.

Although the groove 451b illustrated in FIG. 19 is substantially triangular shaped, it is intended that the groove 451b can be formed as other geometric shapes including those having curved or hollow portions.

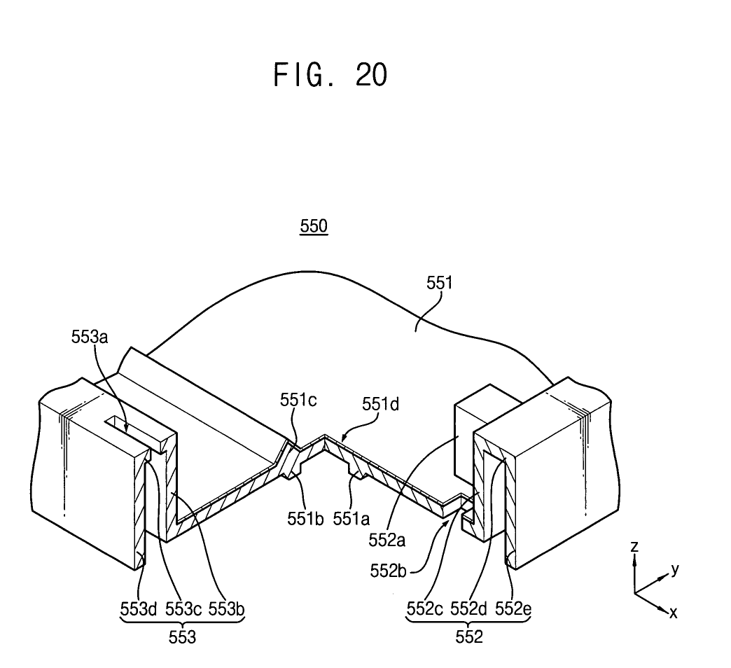

FIG. 20 is a perspective view illustrating a partial portion of a bottom plate according to another embodiment of the present invention.

Referring to FIG. 20, a bottom mold 550 includes a bottom plate 551 including a triangular shaped protruding portion formed on a bottom surface thereof substantially parallel with the lamps and a lattice type rib formed on a rear surface thereof. A reflective layer is formed on substantially the whole bottom surface of the bottom plate 551.

The first sidewall 552 of the bottom mold 550 includes a first member 552c protruded from the first edge portion of the bottom plate 551 substantially along the +z direction, a second member 552d protruded from an end portion of the first member 552c substantially along the +x direction, and a third member 552e protruded from an end portion of the second member 552d substantially along the −z direction. Although the present embodiment describes the first member 552c as protruding from the bottom plate 551 at a right angle, the first member 552c can protrude from the bottom plate 551 at an acute angle less than about 90°.

The second sidewall 553 of the bottom mold 550 includes a fourth member 553b protruded from the second edge portion of the bottom plate 551 substantially along the +z direction, a fifth member 553c protruded from an end portion of the fourth member 553b substantially along the −y direction, and a sixth member 553d protruded from an end portion of the fifth member 553c substantially along the −z direction. The bottom securing holes are formed on the fifth member 553c for securing the bottom mold 550 to the upper mold 260. Although the present embodiment describes the fourth member 553b as protruding from the bottom plate 551 at a right angle, the fourth member 553b can protrude from the bottom plate 551 at an acute angle less than about 90°.

Similar to bottom mold 250 illustrated in FIG. 7, bottom mold 550 includes a plurality of protruding portions 552a formed on an inner surface of the first sidewall 552 extending toward the −x direction, and plurality of holes 552b extending through the bottom plate 551 formed between the protruding portions 552a.

A first rib 551a is disposed on the rear surface of the bottom plate 551 substantially parallel with the first sidewall 552, and the second rib 551b is disposed on the rear surface of the bottom plate 551 substantially parallel with the second sidewall 553. The triangular shaped protruding portion 551c is formed on the bottom surface opposite the rear surface of the bottom plate 551 substantially in the x-axis direction, and reinforces a bending strength of the bottom plate 551. A reflective layer is coated on substantially the whole bottom surface including the triangular shaped protruding portion 551c, so that a dark region due to two lamps adjacent to each other is minimized. In the present embodiment, the reflective layer includes a metal layer having superior reflection efficiency such as an aluminum layer.

According to the present invention, the metal bottom chassis is employed with the bottom mold formed by an injection molding process, so that a weight of the backlight assembly is reduced, a number of parts of a substrate for a display apparatus may be reduced, and where a weight may be reduced of the LCD apparatus including the above backlight assembly.

In addition, rattle noises in a backlight assembly may be remarkably reduced as compared with the metal bottom chassis. When the bottom chassis comprises a metal, various metallic frictions between the bottom chassis and various members or parts received in the bottom chassis generate various noises in the backlight assembly. However, since the bottom mold of the present invention comprises a material suitable for the injection molding process, the metallic frictions are substantially reduced in the backlight assembly, thereby reducing the rattle noises.

Furthermore, a strength-reinforcing member is formed on a surface of the bottom mold for reinforcing a bending strength of the bottom mold against a bending moment applied to the bottom mold. Alternative exemplary embodiments include the strength-reinforcing member having a protruding rib and a recessed groove. The strength-reinforcing member may be formed along one direction, or may be formed in two directions substantially perpendicular to each other, thereby forming a lattice shape.

Having described the exemplary embodiments of the present invention and its advantages, it is noted that various changes, substitutions and alterations can be made herein without departing from the spirit and scope of the invention as defined by appended claims.

What is claimed is:

1. A receiving unit comprising:
a bottom plate;
a plurality of sidewalls protruding from the bottom plate so that a receiving space is defined by the sidewalls and the bottom plate; and
a strength-reinforcing member integrally formed on a surface of the bottom plate, the strength-reinforcing member reinforcing a bending strength of the bottom plate.

2. The receiving unit of claim 1, wherein the bottom plate, the sidewalls, and the strength-reinforcing member comprise a non-metallic material.

3. The receiving unit of claim 1, wherein the sidewalls include a first member protruded from a first edge portion of the bottom plate, a second member protruded from an end of the first member, and a third member protruded from an end of the second member.

4. The receiving unit of claim 1, wherein the bottom plate, the sidewalls, and the strength-reinforcing member comprise a polycarbonate.

5. The receiving unit of claim 1, wherein the strength-reinforcing member includes a rib protruding from a rear surface of the bottom plate.

6. The receiving unit of claim 1, wherein the strength-reinforcing member comprises a geometric shaped portion.

7. The receiving unit of claim 1, wherein the strength-reinforcing member is formed having a surface defining a groove portion.

8. The receiving unit of claim 1, further comprising a reflective layer coated substantially on a whole surface of the bottom plate opposite a rear surface of the bottom plate.

9. A backlight assembly comprising:
an optical unit that generates a light; and
a receiving unit including a bottom plate, a plurality of sidewalls protruding from the bottom plate, and a strength-reinforcing member integrally formed on a rear surface of the bottom plate, wherein the strength-reinforcing member reinforces a bending strength of the bottom plate, and the optical unit is configured to be received in a receiving space defined by the sidewalls and the bottom plate.

10. The backlight assembly of claim 9, wherein the strength-reinforcing member includes a rib protruding from the rear surface of the bottom plate, and a width of the rib is in a range of about ½ times to about ⅔ times a thickness of the bottom plate.

11. The backlight assembly of claim 9, wherein the strength-reinforcing member includes a rib protruding from the rear surface of the bottom plate, and a protruding length of the rib is in a range of about ½ times to about ⅔ times a thickness of the bottom plate.

12. The backlight assembly of claim 9, wherein the strength-reinforcing member is formed having a surface defining a groove portion.

13. The backlight assembly of claim 9, wherein the receiving unit comprises a material formed with an injection molding process.

14. The backlight assembly of claim 9, wherein the receiving unit comprises a non-metallic material.

15. The backlight assembly of claim 9, wherein the optical unit further includes at least one lamp and at least one lamp holder for covering an end portion of the lamp, wherein the sidewall includes at least one hole in which the lamp holder is received.

16. A display apparatus comprising:
an optical unit that generates a light;
a display panel on which images are displayed using the light; and
a first receiving unit including a bottom plate and a plurality of sidewalls protruding from the bottom plate, the receiving unit comprising a material used with an injection molding process, and the optical unit and the display panel being received in a receiving space defined by the sidewalls and the bottom plate.

17. The display apparatus of claim 16, further comprising a strength-reinforcing member formed on a surface of the bottom plate, the strength-reinforcing member reinforcing a bending strength of the bottom plate.

18. The display apparatus of claim 17, wherein the strength-reinforcing member is substantially parallel with a longitudinal sidewall of the bottom plate of a substantially rectangular shape.

19. The display apparatus of claim 17, wherein the strength-reinforcing member is substantially perpendicular to a longitudinal sidewall of the bottom plate of a substantially rectangular shape.

20. The display apparatus of claim 17, wherein the strength-reinforcing member is formed into a lattice shape on the surface of the bottom plate.

21. The display apparatus of claim 17, wherein the strength-reinforcing member includes a rib protruding from a rear surface of the bottom plate.

22. The display apparatus of claim 17, wherein the strength-reinforcing member includes a groove having a predetermined depth from a surface of the bottom plate.

23. The display apparatus of claim 16, wherein a plurality of holes is formed on an edge portion of the bottom plate.

24. The display apparatus of claim 23, wherein the edge portion on which the holes are formed corresponds to a sidewall substantially perpendicular to a longitudinal portion of the bottom plate of a substantially rectangular shape.

25. The display apparatus of claim 23, wherein a protruding portion is formed on the edge portion of the bottom plate between the holes adjacent to each other, the protruding portion being protruded from the sidewall protruding from the edge portion of the bottom plate.

26. The display apparatus of claim 16, further comprising a triangular shaped protruding portion integrally formed on a bottom surface of the bottom pate corresponding to a rear surface of the bottom plate.

27. The display apparatus of claim 16, further comprising a reflective layer coated on a surface of the bottom plate.

28. The display apparatus of claim 16, further comprising a second receiving unit that is secured to the first receiving unit, the display panel being disposed between the first and second receiving units.

29. The display apparatus of claim 16, wherein the material of the receiving unit comprises a non-metallic material.
